(19) United States
(12) Patent Application Publication
(10) Pub. No.: US 2022/0036232 A1
(43) Pub. Date: Feb. 3, 2022

(54) TECHNOLOGY FOR OPTIMIZING ARTIFICIAL INTELLIGENCE PIPELINES

(71) Applicant: International Business Machines Corporation, Armonk, NY (US)

(72) Inventors: Dhavalkumar C. Patel, White Plains, NY (US); Shrey Shrivastava, White Plains, NY (US); Wesley M. Gifford, Ridgefield, CT (US)

(21) Appl. No.: 16/941,615

(22) Filed: Jul. 29, 2020

(51) Int. Cl. G06N 20/00; G06F 8/71; G06F 8/60; G06F 9/38

(52) U.S. Cl. CPC G06N 20/00; G06F 9/3867; G06F 8/60; G06F 8/71

(57) ABSTRACT

Machine logic to change steps included in and/or parameters/parameter value used in artificial intelligence (“AI”) pipelines. For example, the machine logic may control what types of data (for example, sensor data) are received by the AI pipeline and/or have the data is culled in the pipeline prior to application of a machine learning and/or artificial intelligence algorithm.

### BACKGROUND

The present invention relates generally to the field of artificial intelligence pipelines, and more particularly to artificial intelligence pipelines for cloud deployment.

The Wikipedia entry for “artificial intelligence” (as of 16 Jun. 2020) states, in part, as follows: “In computer science, artificial intelligence (AI), sometimes called machine intelligence, is intelligence demonstrated by machines, in contrast to the natural intelligence displayed by humans and animals. Leading AI textbooks define the field as the study of ‘intelligent agents’: any device that perceives its environment and takes actions that maximize its chance of successfully achieving its goals . . . . The traditional problems (or goals) of AI research include reasoning, knowledge representation, planning, learning, natural language processing, perception and the ability to move and manipulate objects. General intelligence is among the field's long-term goals. Approaches include statistical methods, computational intelligence, and traditional symbolic AI. Many tools are used in AI, including versions of search and mathematical optimization, artificial neural networks, and methods based on statistics, probability and economics. The AI field draws upon computer science, information engineering, mathematics, psychology, linguistics, philosophy, and many other fields . . . . Computer science defines AI research as the study of ‘intelligent agents’: any device that perceives its environment and takes actions that maximize its chance of successfully achieving its goals. A more elaborate definition characterizes AI as ‘a system's ability to correctly interpret external data, to learn from such data, and to use those leanings to achieve specific goals and tasks through flexible adaptation.’. . . . AI often revolves around the use of algorithms. An algorithm is a set of unambiguous instructions that a mechanical computer can execute. [b] A complex algorithm is often built on top of other, simpler, algorithms . . . . Many AI algorithms are capable of learning from data; they can enhance themselves by learning new heuristics (strategies, or ‘rules of thumb’, that have worked well in the past), or can themselves write other algorithms. Some of the ‘learners’ described below, including Bayesian networks, decision trees, and nearest-neighbor, could theoretically, (given infinite data, time, and memory) learn to approximate any function . . . ” (footnotes omitted)

The Wikipedia entry for “pipeline (computing)” (as of 16 Jun. 2020) states, in part, as follows: “In computing, a pipeline, also known as a data pipeline, is a set of data processing elements connected in series, where the output of one element is the input of the next one. The elements of a pipeline are often executed in parallel or in time-sliced fashion. Some amount of buffer storage is often inserted between elements. Computer-related pipelines include: . . . Software pipelines, which consist of a sequence of computing processes (commands, program runs, tasks, threads, procedures, etc.), conceptually executed in parallel, with the output stream of one process being automatically fed as the input stream of the next one. The Unix system call [sic] pipe is a classic example of this concept.” (footnotes omitted)

For purposes of this document, “pipeline” is defined in accordance with the descriptions of the preceding paragraph, except: (i) the processes of a pipeline may be executed in serially or parallel; and (ii) the processes of a pipeline form a unit such that all of the processes must be completed successfully to have a successful instance of using the “pipeline.”

For the purposes of this document, an “artificial intelligence pipeline” is hereby defined as any computing pipeline (see definition, above) where at least some of the processes involve artificial intelligence (see definition, above).

The Wikipedia entry for “machine learning” (as of 16 Jun. 2020) states, in part, as follows: “Machine learning (ML) is the study of computer algorithms that improve automatically through experience. It is seen as a subset of artificial intelligence. Machine learning algorithms build a mathematical model based on sample data, known as ‘training data’, in order to make predictions or decisions without being explicitly programmed to do so. Machine learning algorithms are used in a wide variety of applications, such as email filtering and computer vision, where it is difficult or infeasible to develop conventional algorithms to perform the needed tasks. Machine learning is closely related to computational statistics, which focuses on making predictions using computers. The study of mathematical optimization delivers methods, theory and application domains to the field of machine learning. Data mining is a related field of study, focusing on exploratory data analysis through unsupervised learning. In its application across business problems, machine learning is also referred to as predictive analytics . . . . Early classifications for machine learning approaches sometimes divided them into three broad categories, depending on the nature of the ‘signal’ or ‘feedback’ available to the learning system. These were: Supervised learning: The computer is presented with example inputs and their desired outputs, given by a “teacher”, and the goal is to learn a general rule that maps inputs to outputs. Unsupervised learning: No labels are given to the learning algorithm, leaving it on its own to find structure in its input. Unsupervised learning can be a goal in itself (discovering hidden patterns in data) or a means towards an end (feature learning). Reinforcement learning: A computer program interacts with a dynamic environment in which it must perform a certain goal (such as driving a vehicle or playing a game against an opponent) As it navigates its problem space, the program is provided feedback that's analogous to rewards, which it tries to maximise. Other approaches or processes have since developed that don't fit neatly into this three-fold categorisation, and sometimes more than one is used by the same machine learning system. For [example], topic modeling, dimensionality reduction or meta learning. As of 2020, deep learning has become the dominant approach for much ongoing work in the field of machine learning.” (footnotes omitted)

### SUMMARY

According to an aspect of the present invention, there is a method, computer program product and/or system, for use with an original artificial intelligence pipeline (AIP), that performs the following operations (not necessarily in the following order): (i) orchestrating, by a pipeline deployment tool, an examination of the original AIP to yield a set of pipeline revision(s); (ii) producing, by the pipeline deployment tool, a revised version of the AIP, along with associated metadata; and (iii) deploying the revised version of the AIP.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a flowchart showing a second embodiment method performed, at least in part, by the first embodiment system;

FIG. 5 is a diagram helpful in understanding various embodiments of the present invention;

FIG. 6 is another diagram helpful in understanding various embodiments of the present invention;

FIG. 7 is a flowchart showing a third embodiment method;

FIG. 8 is another diagram helpful in understanding various embodiments of the present invention;

FIG. 9 is another diagram helpful in understanding various embodiments of the present invention;

FIG. 10 is another diagram helpful in understanding various embodiments of the present invention;

FIG. 11 is another diagram helpful in understanding various embodiments of the present invention;

FIG. 12 is another diagram helpful in understanding various embodiments of the present invention;

FIG. 13 is another diagram helpful in understanding various embodiments of the present invention;

FIG. 14 is a flowchart showing a third embodiment method; and

FIG. 15 is another diagram helpful in understanding various embodiments of the present invention.

### DETAILED DESCRIPTION

Some embodiments of the present invention are directed to using machine logic to change steps included in and/or parameters/parameter value used in artificial intelligence pipelines. For example, the machine logic may control what types of data (for example, sensor data) are received by the AI pipeline and/or have the data is culled in the pipeline prior to application of a machine learning and/or artificial intelligence algorithm. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

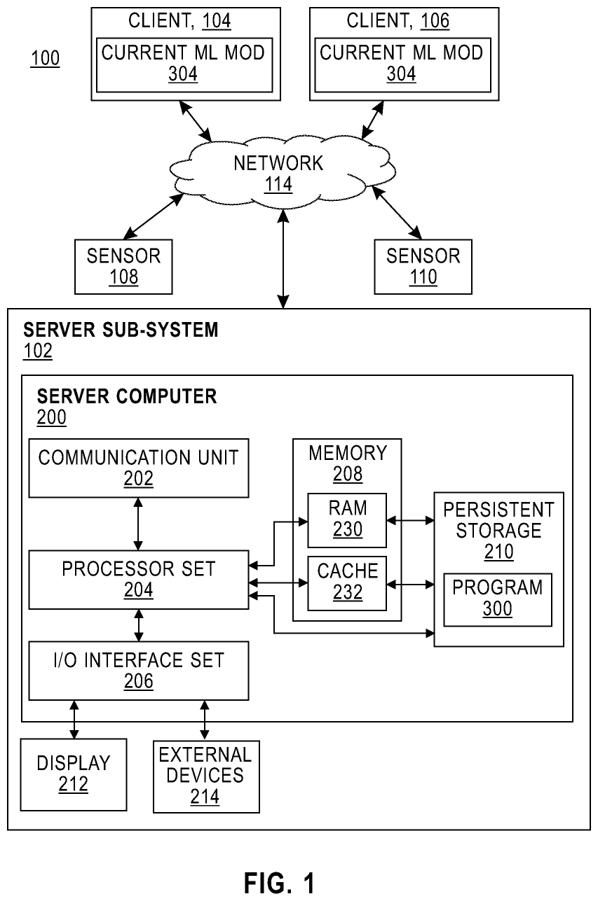

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystem 104 (including a current copy of machine learning (ML) module (“mod”) 304); client subsystem 106 (including a current copy of ML mod 304); sensor set node (or, more simply, “sensor”) 108; sensor 110; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

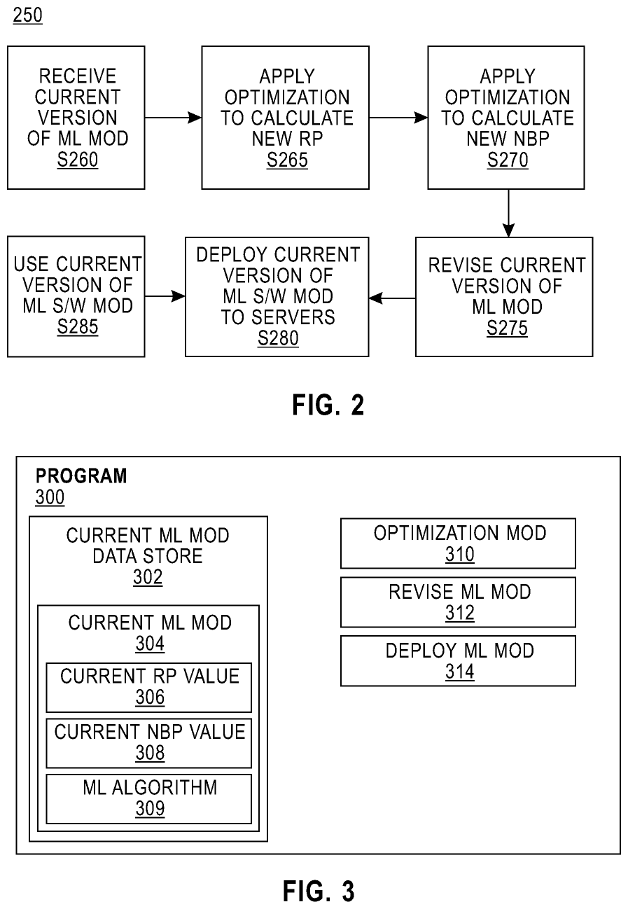

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Before the process of flowchart 250 is discussed, some reference of what the computers system 100 does and how it does it will be discussed in this paragraph and the next paragraph. In this example, computers system 100 controls two fleets of self-driving robots that automatically put tarps over the grass of the playfields within outdoor stadiums (not shown) when there are no events going on and the grass needs protection from excess rain or snow. Client subsystem 104 controls a first fleet at a first stadium, where sensor set 108 is located. Client subsystem 106 controls a second fleet at a second stadium, where sensor set 110 is located. Both client subsystems run a current version of ML mod 304 to determine when to send the fleet out with a tarp. More specifically, an ML will make a “recommendation” (or “prediction”) to send the fleet of robots out at appropriate times. In this example, the “recommendation” is automatically executed by the fleet of robots, unless overridden by a human individual with access to the client sub-system. Alternatively, the “recommendation” may be sent to a human individual (for example, by text message) who ultimately determines whether or not the fleet of robots will be sent as recommended.

Covering the grass too often wastes energy and may also be unhealthy for the grass. On the other hand, not covering the grass often enough can lead to overwatered grass, which is also unhealthy for the grass. Therefore, the current ML mod uses machine learning to intermittently improve the quality of the response made to the data received from the applicable sensor set. In this example, the sensor sets are structured and programmed to provide parameter values for six (6) different parameters (these parameter values are sometimes called input parameter values because they potentially serve as inputs to the current ML mods): (i) temperature parameter (with parameter values measured in degrees Kelvin); (ii) humidity parameter (with parameter values measured in grams of water vapor per cubic meter volume of air); (iii) wind speed parameter (with parameter values measured in meters per second); (iv) playfield-occupied parameter (measured in units of number of human individuals on the playfield); (v) current precipitation parameter (with parameter values measured in average droplets per square foot per minute); and (vi) recent (that is, past 24 hours) precipitation parameter (with parameter values measured in liters per playfield). In this example, these six parameters form the whole universe of parameters that current version of ML mod 304 can potentially use to make its recommendations to have the robots cover the playfield with the tarp. As will be seen in the discussion of flowchart 250, below, it may not always be optimal to use all of these parameters, because a greater number of parameters increases computation resources required and, also, can lead to latency. For example, it does no good to make a recommendation to cover the playfield after a quick, but intense, cloudburst has occurred at the stadium.

Moving now to the discussion of flowchart 250, processing begins at operation S260, where current ML mod data store 302 receives a copy of the current version of ML mod 304. ML mod 304 includes current received-parameters (RP) value 306, current number-of-best-parameters (NBP) value 308 and ML algorithm 309. In this example, and at this juncture of the process, the RP value is as follows: temperature, humidity, wind speed, playfield-occupied, current precipitation and recent precipitation. This means that the current version of ML mod receives, as input, values for all six (6) parameters that the associated sensor set is configured to put out. In this example, and at this juncture of the process, the NBP value is as follows: six (6). This means that the current version of ML mod analyzes all six (6) parameters to decide, on an ongoing basis, whether to make a recommendation to engage the robot fleet with their tarp. As will be seen below, the process of flowchart 250 determines, by machine logic and without substantial human intervention, whether it is optimal for the ML mod to receive all six parameters, and also whether all six parameters should be used in the analysis (or alternatively whether some parameter values should be selectively culled out of the input data before the input data is analyzed to obtain a recommendation.

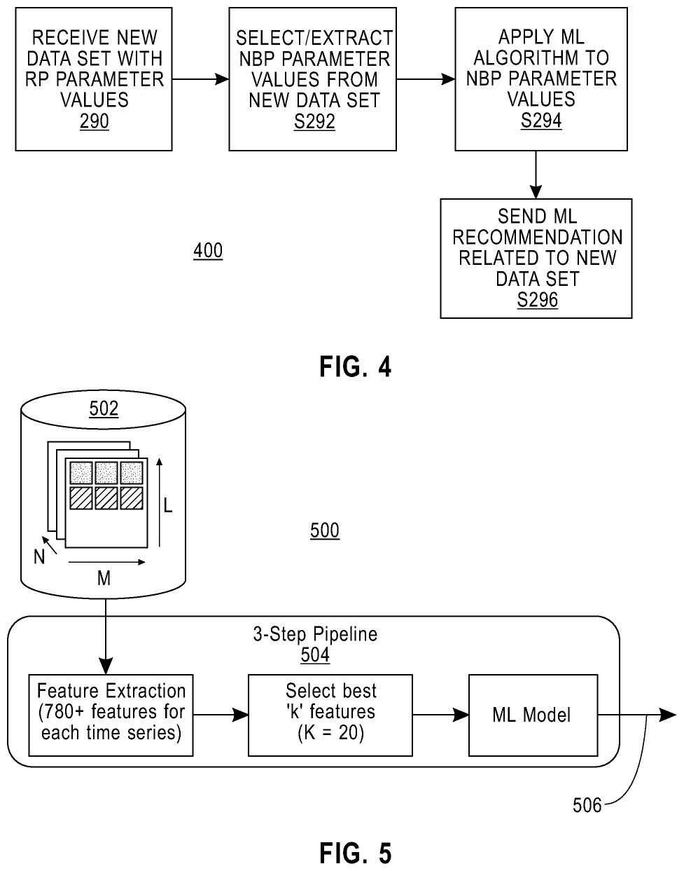

The role of the RP and NBP values can be better understood with reference to flowchart 400 of FIG. 4, which represents the process performed by ML mod 304 when it receives input and decides whether to make a recommendation to deploy the tarp robots. As shown in FIG. 4, processing starts at operation S290, where the ML mod receives parameter values according to the current RP value 306. As stated above, in this example, the RP value starts with all six (6) parameters, so all possible sensor data is at least received into the ML mod when the ML mod is operative. Processing proceeds to S292, where the NBP value 308 determines how many of the received parameters are actually analyzed. In this example, all six (6) parameters are selected to be fully analyzed. This comprehensive approach has lead to latency, which will be address when discussion returns to flowchart 250 of FIG. 2. Staying, for now, with flowchart 400 of FIG. 4, processing proceeds to operation S294, where the parameter(s) selected according to the NBP value are analyzed by ML algorithm 309 to yield a recommendation (in this example the recommendation is either “deploy the robots” or “hold back the robots”). For purposes of this document, an ML algorithm is hereby defined as any algorithm that is subject to machine learning (see definition of ML, above, in the Background section). Typically, an ML algorithm will include an “ML model.” ML models will be discussed further in the following section of this detailed description section. Processing proceeds to operation S296, where the ML mod sends the recommendation to the part of the client subsystem that controls deployment of the robots.

Returning now to flowchart 250, processing proceeds to operation S265, where optimization mod 310 applies its machine logic to calculate an optimal value for RP. Generally speaking, if the quality of the recommendations needs improvement (for example, robots sent out when field is not that wet), then RP may need to be increased. In this example, RP cannot be increased because it is already at its maximal value. On the other hand, if there is latency, as in this example, then it may be optimal to decrease the RP value so that less data and fewer parameter values are received into ML mod 304.

More specifically, in this example, mod 310 determines that the humidity parameter is seldom useful, or instrumental, in forming a good recommendation, so the RP value is changed from six parameters to the following five parameters: temperature, wind speed, playfield-occupied, current precipitation and recent precipitation This will help address the latency issue and is one form of optimization of ML mod 309. More specifically, this sort of optimization is a form of what is sometimes called “feature engineering” or “feature selection.”

Processing proceeds to operation S270, where optimization mod 310 applies its machine logic to calculate an optimal value for NBP. Generally speaking, if the quality of the recommendations needs improvement (for example, robots sent out when field is not that wet), then NBP may need to be increased. In this example, NBP cannot be increased because it is already at its maximal value. On the other hand, if there is latency, as in this example, then it may be optimal to decrease the NBP value so that less data and fewer parameter values are analyzed by ML algorithm 309 of ML mod 304.

More specifically, in this example mod 310 determines that recent precipitation is only conditionally relevant when the wind speed is low. In other words, if a powerful thunderstorm is blowing over the stadium, then recent precipitation becomes less relevant with respect to making good recommendations. In response to this determination by the machine logic of mod 310, the NBP value is changed from six parameters to four parameters (which will be a subset of the five (5) RP parameters determined previously at operation S265. Unlike the RP parameters, the NBP value is not expressed in terms of the identities of specific parameters to be used. Instead, the identity of the four parameters selected from the five received parameters is determined on every pass through the machine logic of mod 304 (that is, each pass through the process of flowchart 400 of FIG. 4). For example, if wind speed is low on a given pass through the logic of mod 304, then wind speed will not be one of the four (4) selected NBP parameters on that pass, in favor of the selection of the recent precipitation parameter value. This will help address the latency issue and is another form of feature engineering and feature selection.

Processing proceeds to operation S275, where revise ML mod 312 revises the current version of ML mod 304, stored in data store 302, so that the RP and NBP values are revised as discussed above.

Processing proceeds to operation S280, where deploy ML mod 314 deploys the current (that is, just updated) version of ML mod 304 throughout computers system 100 (in this example that is deployment to client subsystem 104 for the first stadium and client subsystem 106 for the second stadium).

Processing proceeds to operation S285, where the client subsystems use the updated version of ML mod 304 to make recommendations, on an ongoing basis, regarding whether or not to deploy the tarp robots. Because of the optimizations of the process of flowchart 250, the latency is reduced and the grass of the playfields of the stadiums will now be healthier than it ever has been before.

### III. Further Comments and/or Embodiments

Some embodiments of the present invention may recognize one, or more, of the following facts, potential problems and/or potential areas for improvement with respect to the current state of the art: (i) due to increasing adoption of Industry 4.0, many industrial manufacturing processes are closely monitored by thousands of sensors in real time; (ii) building data driven AI-based solutions to predict machinery failure, anomaly detection, survival analysis is a common interest in Industry 4.0; (iii) the real IoT (Internet of Things) sensor data present challenges due to the volume, noise, missing values, irregular samples, etc.; (iv) automation in AI has provided an easy to use platform that simplifies the process of building models; (v) the current lifecycle of building an AI Model in the majority of applications comprises two stages as follows: (a) the authoring phase operates on input data and outputs a best “pipeline”—the pipeline consists of a sequence of steps such as feature engineering, feature selection, feature transformation and machine learning model, and (b) the deployment phase deploys the discovered and trained “pipeline” on the cloud and generates a single end-point for real time scoring; (vi) it is generally assumed that the data schema of scoring record is same as the schema of data used during authoring phase; (vii) the objective of authoring phase is to discover a pipeline that satisfies the performance criteria; and/or (viii) however, deploying a discovered pipeline directly is not advisable because it was designed for determining the right model, not efficiency during deployment.

Some embodiments of the present invention may include one, or more, of the following operations, features, characteristics and/or advantages: (i) a method and system for optimizing AI pipelines for cloud deployment; (ii) a pipeline deployment tool which orchestrates the examination of a pipeline, its subsequent revision, and produces a new pipeline along with associated metadata to facilitate deployment; (iii) a pipeline inspection tool to examine existing trained AI pipelines and identify steps where potential revisions could occur; (iv) a revision planner which evaluates potential candidate revisions and identifies: (a) which revisions should be made given available resources, and (b) the order in which those revisions should proceed; (v) pipeline step revision component which identifies how to revise a particular step in a pipeline according to: (a) a known set of step types and rules which can be applied (white box techniques) to reduce both input requirements and model complexity, and/or (b) a method to examine inputs and outputs of a step to infer potential reductions in either input or model complexity, without understanding the specifics of the step (black box); (vi) revision propagator component which takes a pipeline with a revised step, along with information about the revision, to propagate changes to ensure consistency and correctness of the pipeline; and/or (vii) tool to compare a candidate revised pipeline and the original pipeline to identify the fidelity with which the candidate reproduces the original pipeline behavior.

Some embodiments of the present invention may include one, or more, of the following operations, features, characteristics and/or advantages: (i) automated optimization of an AI model at the deployment stage; (ii) after training an AI model, the system will optimize the steps it takes to perform the same calculation with less data overhead; (iii) this means combining steps to make for faster result calculation for new data to make overall process faster; (iv) a system to optimize a training model before a deployment step; (v) analyzes the training model steps and reduces those steps for calculating the results without losing accuracy in an automated manner; (vi) performs optimization of data features (hence reducing time taken) by AI model for a single round of prediction by a trained model; (vii) modifies a machine learning model to reduce the size; (viii) includes accuracy aspect of a model while modification is taking place; (ix) provides a way to reduce the data needed for functioning the ML (machine learning) model; (x) deploys pipelines composed of feature engineering as well as a model; (xi) implements multiple modules on inspecting the machine learning pipeline; (xii) understands a feature engineering aspect of a pipeline and working of machine learning model; (xiii) avoids interfering with the model training process; (xiv) the pipeline optimization module is a separate module which allows a user the flexibility to use any automated machine learning tool; (xv) optimizes machine learning pipelines to create more efficient execution of these pipelines; (xvi) improves the execution of machine learning models by removing redundancy, etc.; (xvii) optimization of the AI models such that the steps for getting predictions is lesser; (xviii) faster AI model response time to the user, less memory footprint and data overhead to send over the network; (xix) operated in the post-training and pre-deployment stage of AI lifecycle; and/or (xx) optimizing model steps to reduce data overhead on network and giving faster response time to the user.

Machine logic and associated computerized methods for pipeline optimization (sometimes herein referred to as “Pi-Opt”) will now be discussed in the following paragraphs.

Automation in Artificial Intelligence and in hybrid cloud style computer systems has led the creation of easy-to-use platforms that simplify the process of building and deploying AI/ML models. The current lifecycle of AI Models, in the majority of applications, includes two (2) phases as follows: (i) Authoring Phase: operations of this phase on the input data and the set of steps which discover the best performing AI pipeline for data (it is noted that the pipeline consists of a sequence of data transformation steps such as feature engineering, feature selection, feature transformation and training the right machine learning model); and (ii) Deployment Phase: operations in the deployment phase deploy the discovered and trained pipeline on a cloud style computer system and generate a single end-point for real time scoring. It is generally assumed that the data schema for scoring record is same as the schema of data used during authoring phase. The objective of authoring phase is to discover a pipeline that satisfies the performance criteria. One of the key observations in the AI model lifecycle is that most of the times, the AI pipeline that is discovered is directly deployed on the cloud for scoring. However, this is not the optimal solution when deploying AI pipeline in real-time industrial scoring setting. The issues that can be seen in such deployments arise due to that fact that the AI pipeline in question is built for training and discovering the right model, but it is not efficient for deploying industrial scale payloads. Two types of inefficiency issues which arise due to such deployments will be respectively discussed in the following two paragraphs.

Information Overload: the trained AI pipeline contains information that is no longer needed, for example, extra transformation steps, model evaluation which are important in authoring phase but resulting in unnecessary steps in the scoring of new data points. It is noted that information overload by itself does not cause any issues in the deployment, but it is an example of potential inefficiency that some embodiments of the present invention may work to correct. Information overload type inefficiency is typically caused by a design which incurs storage of useless information. Because the deployed AI pipeline will be the ground truth for future instances, this will lead to spreading of redundant information and cause more significant issues in other applications.

Resource Mismanagement: Due to information overload, the scoring instance received by the deployment will go through extra steps just to predict the outcome of this instance. This leads to increasing compute requirements and network overhead in real-time industrial settings, where model scoring is done frequently this can have a tremendous impact on resource requirements and cost of delivering a solution.

To address the issue of optimal deployments of AI pipelines, some embodiments of the present invention re-factor an authored pipeline for deployment purposes of ensuring efficiency, while maintaining the same level of model fidelity.

AI model development and deployment lifecycle will now be discussed. In a typical environment AI model lifecycle, the authoring phase which involves stages like—Data Exploration, Model Training and Model Evaluation is followed by the deployment phase which has the Model Deployment stage. Optimization of AI pipelines is currently a missing component in AI model authoring and deployment lifecycle. Some embodiments of the present invention sit in between the authoring and the deployment phase to streamline AI pipeline to minimize network overhead, memory footprint, computational requirements and improve response time of deployed model.

One key term relating to the technology of the present invention is “AI model.” As the term is used herein, an “AI model” is a mathematical construct that relates input variables to a prediction (real number, class label, probability, etc.).

Another key term relating to the technology of the present invention is “AI pipeline.” As the term is used herein, and “AI pipeline” is composed of a series of steps, which realize a particular AI model and corresponding pre/post processing steps necessary for that model and any accompanying parameters.

Another key term relating to the technology of the present invention is “pipeline step.” As the term is used herein a “pipeline step” is a single step in a pipeline, such as transformation, feature selection, normalization, machine learning model.

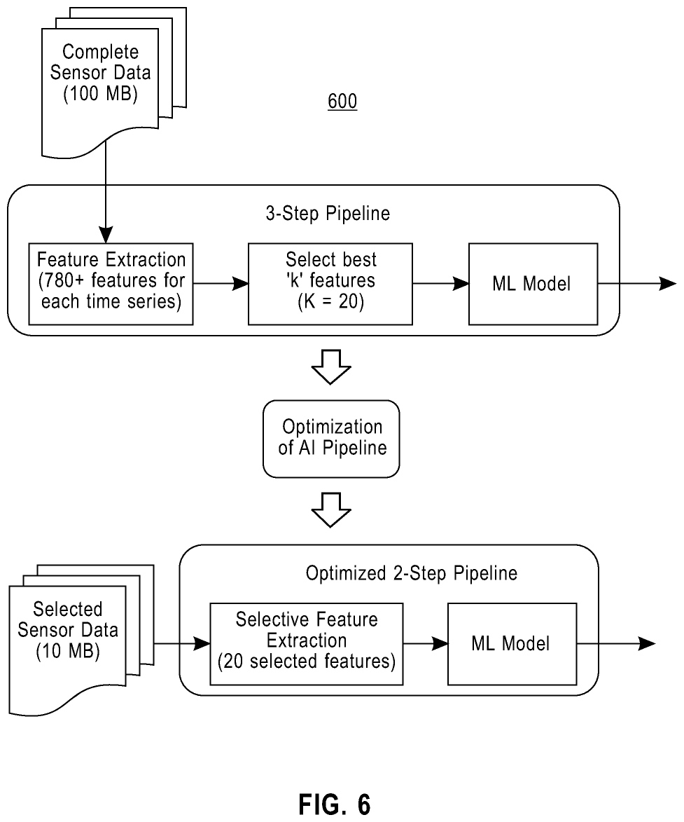

As shown in FIG. 5, diagram 500 includes: multi-variate time series block 502 (which includes episodic process data); three-step pipeline block 504; and trained AI pipeline output path 506. The example pipeline of diagram 500 may be used with a pipeline deployment tool which is shown in diagram 600 of FIG. 6. The pipeline deployment tool orchestrates the examination of a pipeline, its subsequent revision, and produces a new pipeline along with associated metadata to facilitate deployment. An example of potential benefits of pipeline deployment tool 600 may include: (i) reduced 3-step pipeline to a 2-step one by streamlining feature extraction and selection reduced memory footprint reduced time and space complexity; (ii) all data requirements reduced from complete sensor data to a selected subset; (iii) reduced network overhead improved response time; and/or (iv) optimized pipelines allow for improved scalability and more efficient infrastructure utilization allowing greater density per node.

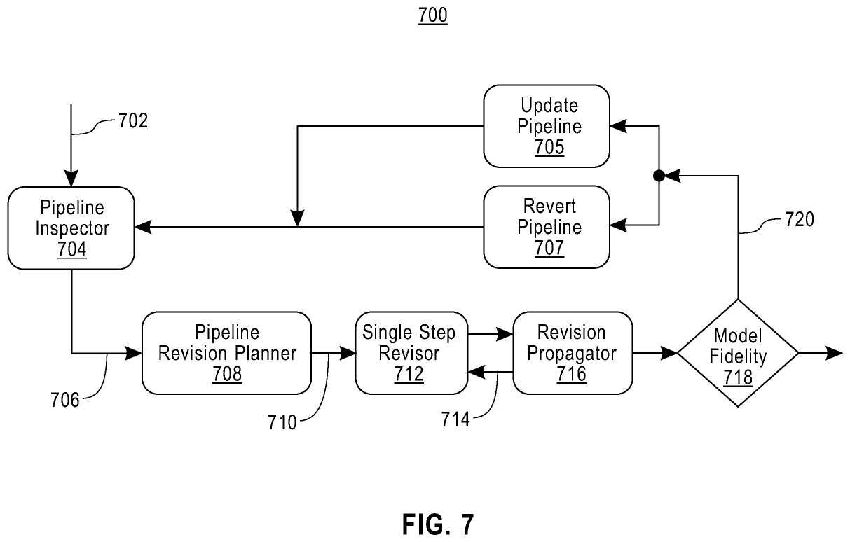

Component-level architecture will now be discussed. The component-level architecture of an embodiment of the present invention is shown by diagram 700 of FIG. 7. Diagram 700 shows an iterative process to identify steps that can be revised, make those revisions, and propagate changes necessary to ensure consistency of the pipeline. Diagram 700 includes: pipeline metadata input 702; pipeline inspector block 704; candidate steps path 706; pipeline revision planner block 708; juncture 710 (which steps to revise and in what order); single step revisor block 712; juncture 714 (revised step, revision information); revision propagator block 716; update pipeline block 705; revert pipeline block 707; model fidelity block 718; and optimize pipeline metadata path 720.

In operation, pipeline inspector block 704 examines the existing trained AI pipelines and identifies the steps where potential revisions could be performed. Pipeline revision planner block 708 evaluates potential candidate revisions and identifies: (i) which revisions should be made given available resources; and (ii) the order in which those revisions should proceed. Single step revisor block 712 performs pipeline step revision by determining how to revise a particular step in a pipeline according to: (i) a known set of step types and rules which can be applied (white box techniques) to reduce both input requirements and model complexity; and/or (ii) examination of inputs and outputs of a step to infer potential reductions in either input or model complexity, without understanding the specifics of the step (black box techniques). Revision propagate or block 716 takes a pipeline with a revised step, along with information about the revision, to propagate changes to ensure consistency and correctness of the pipeline. Model fidelity block 718, in this embodiment, takes the form of a pipeline reviewer, or tool, to compare a candidate revised pipeline and the original pipeline in order to determine the fidelity with which the candidate reproduces the original pipeline behavior.

In this paragraph, pipeline inspection will be discussed. In this embodiment, pipeline inspection includes detecting if a step of a pipeline can be optimized. This may be done by: (i) white-box techniques: comparing with a known set of operations and model types for which optimizations are known beforehand (for example, tree-based models which do not leverage particular input columns, or select k-best features which do not leverage some previously generated features); and/or (ii) black-box: examine input and output of a step to infer mapping, and if the mapping shows that particular inputs are not needed for the output, then there is a potential for optimization. Steps could include operation such as column reduction, column expansion, and column transformation.

In this paragraph, revision planning will be discussed. The machine logic which performs revision planning: (i) is provided with a set of steps which can be revised and associated metadata; (ii) prioritizes steps based on a score that takes into consideration the following factors: (a) cost: retraining of models is high cost, directly reducing input to a tree which doesn't use certain columns is low (time and resources to retrain, etc.), (b) simplicity: operation level simplicity, (c) position of step: the position of steps in the pipeline; and/or (iii) value: quantified in terms of the reduction in number columns and size of reduced columns (bytes). A sort operation is performed ort based on descending score, with score of revising step i given by the following Expression (1):

score(i)=simplicity(i)+value(i)+step-position(i)−cost(i) (1)

In this paragraph, the process of revising a step will be discussed. For a given step, identify an action to take on the step, with possible actions including: (i) removal of step; or (ii) update of step (retrain or reindex model to work with fewer inputs, or generate only certain features). Once step is updated, generates necessary metadata for the changes that it made to be (see optimize pipeline metadata path 720).

In this paragraph revision propagation will be discussed. As shown at juncture 714, there is a handshake mechanism between revision propagator block 716 and single step revisor block 712. The purpose of the revision propagator block is to: (i) check whether revision propagation is needed or not; and (ii) if so, identify the prior step that needs to be revised. The revision propagator block and single step revisor block work together to produce a consistent and correct pipeline.

In this paragraph, the operation of model fidelity block 718 will be discussed. There is a need to ensure that pipeline behaves similarly to un-optimized pipeline. To do this, block 718 compares the loss function or accuracy of the revised pipeline with the original using sample training data.

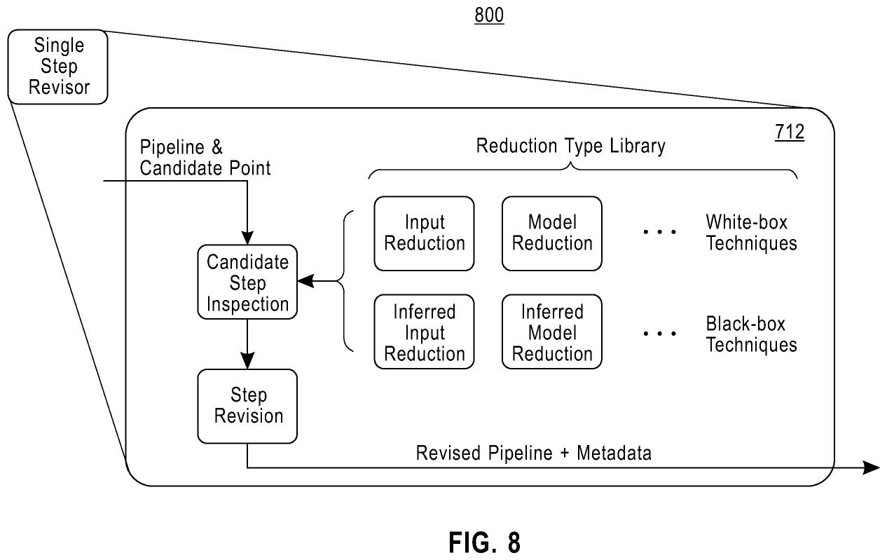

As shown in FIG. 8, diagram 800 shows a single step revisor 712.

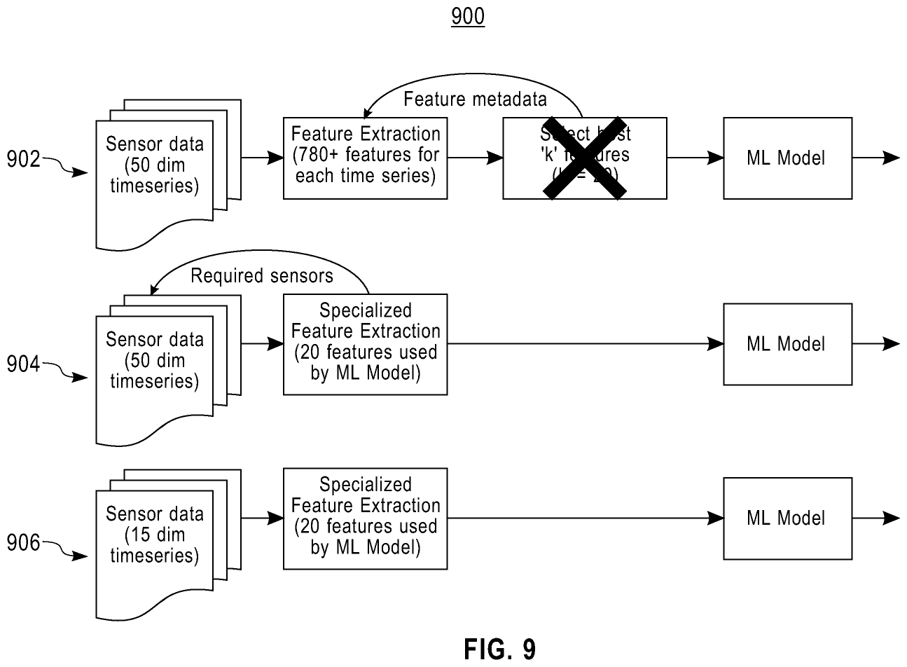

As shown in FIG. 9, diagram 900 shows the handshake mechanism between revision propagator block 716 and single step revisor block 712, which operates at juncture 714. Diagram 900 includes: first tier 902 (applicable after the first application of the step revisor); second tier 904 (applicable after application of propagator and then next iteration of step revisor); and third tier 906 (applicable after final application of step revisor, no further revisions needed).

In some embodiments of the present invention, optimization of an artificial intelligence pipeline may include: (i) pipeline profiling; (ii) pipeline pruning; and/or (iii) training information metadata.

Behavior of different modules on AI pipeline will now be discussed. Feature engineering increases data. This stage can lead to data expansion/explosion based on the number of features generated. Feature selection reduces data. This stage removes many features from the dataset to contain information (PCA (that is, principal component analysis), Sparse PCA, Information Gain, Select K Best). Modelling uses a subset of the data and/or features while predicting (tree based estimators, logistical regression, sparse Neural Networks).

Some embodiments of the present invention may include one, or more, of the following operations, features, characteristics and/or advantages: (i) a mechanism to optimize/profile a trained AI pipeline to make multi-step complicated data transformations to straightforward steps in the deployed pipeline; (ii) with the help of white-box techniques, machine logic according to the present invention can inspect models with specific types of information to make many deterministic decisions; (iii) considers resource constraints while performing real-time scoring (for example, scoring scenarios: frequency: every 5 minutes, large data: ‘x’ gigabytes of data) and/or (iv) considers resource costs (for example, network for sending large data, storage space, processing cost for feature engineering).

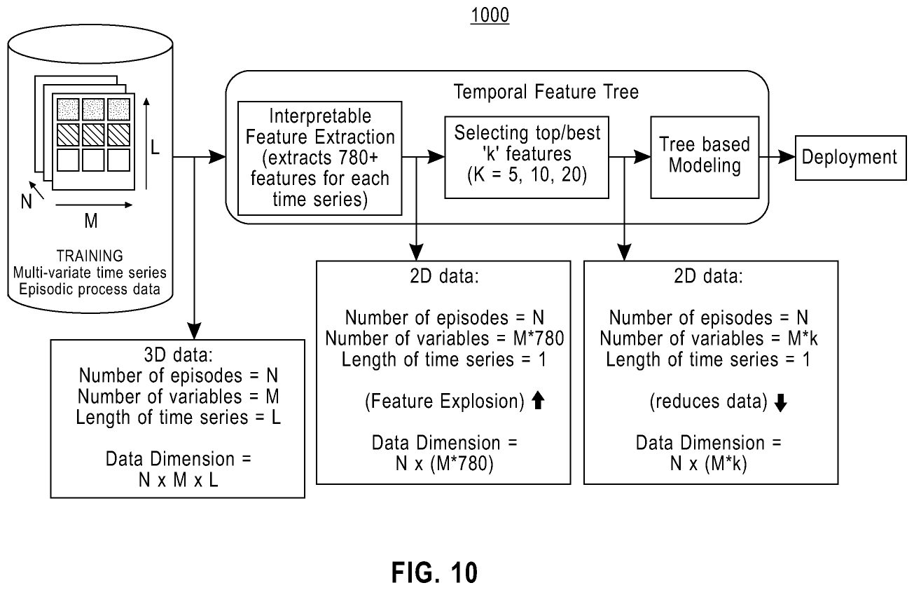

As shown in FIG. 10, diagram 1000 shows a temporal feature tree pipeline without optimization. FIG. 10 outlines a process of training machine learning model for given Multi-variate time series episodic data. In this example, it is assumed that the input to the system is Multi-variate time series episodic data. An episode is one round of execution of a process. During this round of execution, a time series of multiple variables is generated. Diagram 1000 illustrates a modeling process that analyzes each episode data separately and classifies whether an episode has some problem (for example, a typical supervised classification problem). Altogether, the input data constitutes a 3D (three-dimensional) Tensor, where, dimension 1 is the number of episodes (N), dimension two us the number of variables (M), and dimension 3 is the length of time series (L). Overall, the total dimension size is =N×M×L. diagram 1000 also explain how Interpretable Features are extracted. In diagram 1000, a system according to an embodiment of the present invention extracts 700+ features for each time series. These features try to summarize the temporal behavior of an individual feature times series. Some example of features includes first order summary statistics such as mean, standard deviation, etc. The feature extraction process helps to reduce the long time series into a bounded feature vector. In diagram 1000, one of the outputs has a size of N×(M×780). In some cases, the 780 bound dimension is too large or contains an overflow on information. So, the user has an option to further prune the size. In diagram 1000, a feature selection method is utilized, where the number of features to be selected for subsequent analysis can be adjusted. Selecting top/best ‘k’ features (K=5, 10, 20). Assume if the variable k is set to 10, then the size of final output from current block is N×(M×10). Finally, the N×(M×10) set of data is passed to any interpretable tree-based modeling to generate the final tree. The trained model is deployed for real time usage.

As used herein, the phrase “temporal feature tree pipeline” is defined as an ML pipeline that first extracts temporal features from time series data and then prepares a tree-based machine learning model. There are many existing tree-based ML models, such as Decision tree, Random Forest, etc. Similarly, there are many kinds of temporal features to be extracted such as first order statistics (mean, max, std) or higher order statistics.

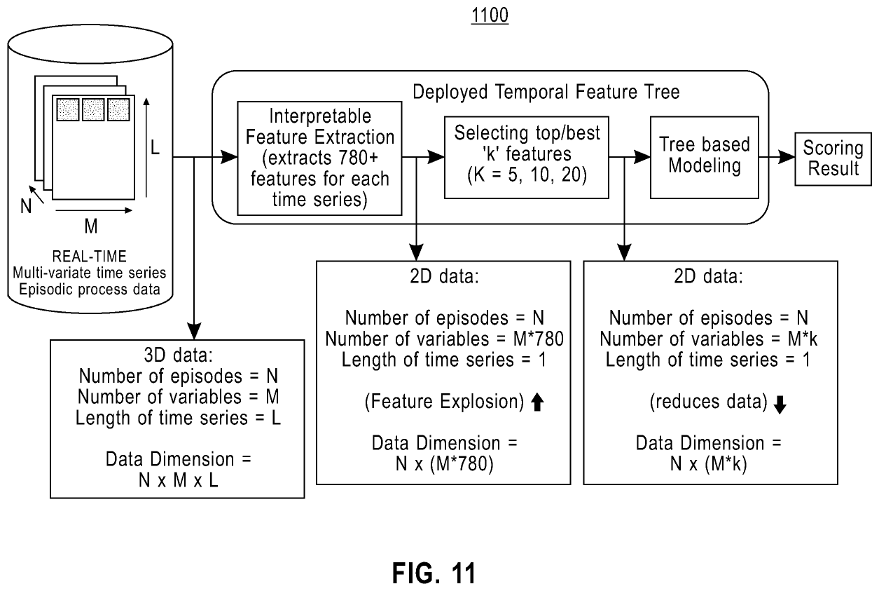

As shown in FIG. 11, diagram 1100 shows a temporal feature tree pipeline during scoring without pipeline optimization. Diagram 1100 demonstrates the usage of a model that is deployed on a cloud. As described in connection with diagram 1000, the input is an incoming time series, collected from some real time process. It will pass through the same set of feature extraction process, followed by selecting k-feature as discovered by training process. Next, the features are passed to trained model to make a prediction. The output is returned to the user. In the process, the last block only uses (N×M×10) features however the feature extraction module still discovers (N×M×780) features (as shown by the Feature Explosion Arrow of diagram 1100). This is certainly overhead while performing scoring. In this example, there are two overhead features as follows: (i) time to extract features that are not being used in later stage; and (ii) sending the features over payload at the time of scoring increase payload size. In summary, diagram 1000 explains the training process, whereas diagram 1100 explains the real time use case of scoring scenario. In a majority of cases, the training is offline, whereas scoring is performed in real time. Current model training does not address this gap directly. As a result, there is a need of an additional optimization tool that help to fill the gap. For example, assume an end user wants to deploy the model on edge device, and in such situation, a tool is helpful to make some adjustments such that the features that are not being used for scoring are not generated.

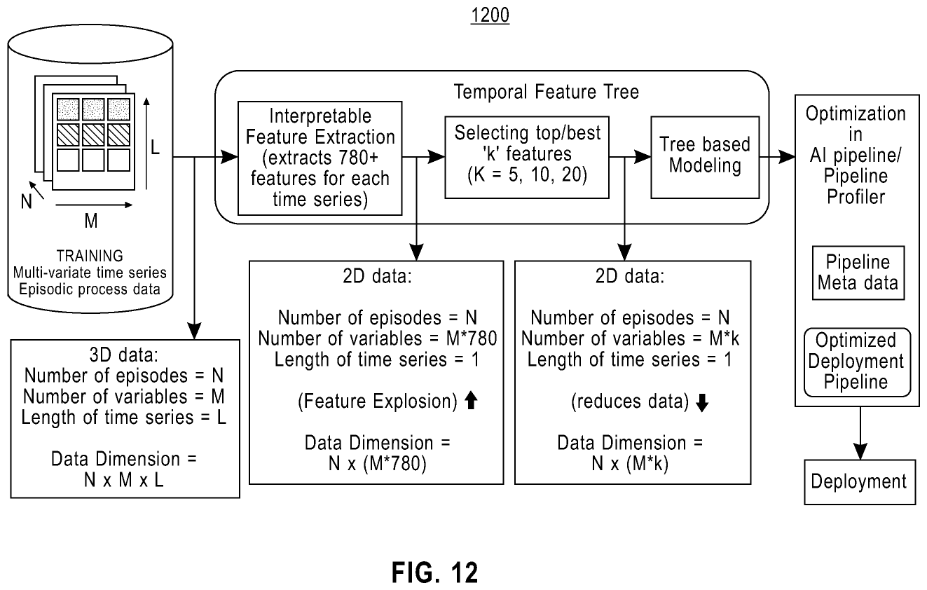

As shown in FIG. 12, diagram 1200 shows a temporal feature tree pipeline where optimization according to an embodiment of the present invention is applied. Diagram 1200 shows an important block at the end of model training process. There is a need of an optimization tool. The tool should able to work with many existing tools that are used to discover ML pipeline in automated manner such as AutoAI, TPOT, etc. FIG. 12 shows a possible place where a tool according to the present invention can be utilized for meeting the need. Diagram 1200 highlights two important modules: (i) pipeline meta data; and (ii) Optimized Deployment Pipelines. Because optimization tools need to communicate back to end user about what information (that is, features) needed to be plugged if optimized model is deployed instead of original model. This information is preserved in pipeline meta data. Optimized Deployment Pipelines store all trained pipelines that are generated after revision and user has an option to pick the one based on need.

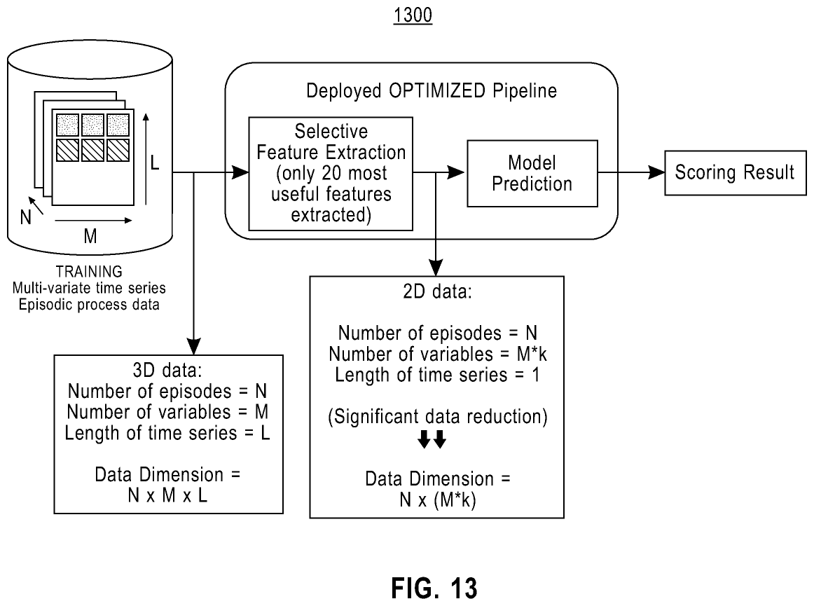

As shown in FIG. 13, diagram 1300 shows a temporal feature tree pipeline during scoring after pipeline optimization according to the present invention has been applied. Diagram 1300 demonstrates the use of an optimized pipeline in real time scoring. Diagram 1300 highlights the importance for the current exampling in term of extracting only needed feature (only 20 features). In the example of diagram 1300, a user has an option to send the data only for those sensors that are necessary for making a decision.

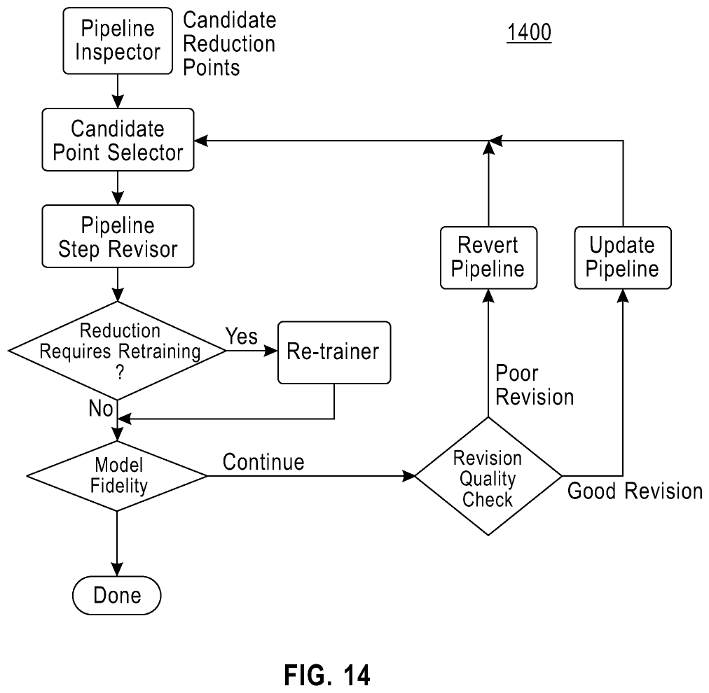

As shown in FIG. 14, diagram 1400 shows a flowchart representing a method for AI pipeline optimization. Diagram 1400 outlines the pipeline refinement process. It is an iterative complex process that inspect each component of pipelines in a systematic way and finds the optimized pipelines. In many respects diagram 1400 is similar to diagram 700, discussed above in connection with FIG. 7.

Computer code for a graph extraction algorithm according to an embodiment of the present invention:

Input: A pipeline P = [symbol] p₁, p₂, . . . , pₖ [symbol]
Output: Weighted graph, G = (V, E, ω), ω:E [symbol] [symbol]
V ← {}
E ← {}
ω ← ()
for j ← k to 1 do
| if j = k then
| | V ← V ∪{(k, 1)}
| else
| | n ←|output(pⱼ)|
| | Sⱼ ←{(j, f):f ∈[1, . . . ,n]}
| | V ← V ∪Sⱼ
| | for a, b, ∈ Sⱼ × Sⱼ₊₁ do
| | | d = dependence(a, b)
| | | if d > 0 then
| | | | E ← E ∪ {(a, b)}
| | | | ω((a, b)) ← d
| | end
| end
end

In the graph extraction algorithm of the preceding paragraph the dependence calculation is based on the type of step in the pipeline. In this example, for feature selection those features selected will have weight 1. For other step types, the weighting can be inferred based on model weights, or by using black box techniques.

The algorithm details of step revision and propagation will now be discussed. The step revisor will search through available revision methods and find one that is appropriate for a current step in the pipeline. If the step is feature selection, then machine logic uses the dependency graph to revise the step and pipeline according to the following algorithm (presented here in pseudo-code):

```
Input: A pipeline P = [symbol] p₁, p₂, . . . , pₖ [symbol] , a weighted dependency
          graph G = (V, E, ω), ω : E [symbol] [symbol]   , a step j which is a feature
          selection step, a weight threshold λ indicating the minimum
          required dependence.
Output: A consistent revised pipeline with feature selection removed,
          P′ = [symbol] p₁′, p₂′, . . . , pₗ′ [symbol] .
P′ ← [symbol] [symbol]
/* Everything after step j remains the same */
for m ← j +1 to k do
| P′ ← append(P′, pₘ)
end
Sⱼ^{′} ← Sⱼ
/* For steps before j the dependency graph is used to
    rewrite the steps */
for m ← j-1 to 1 do
| Sₘ′ ← {n′ : n′ ∈ Sₘ and (∃n)[n ∈ Sₘ₊₁^{′} and ω(n, n′) >λ]}
| pₘ′ ← revise(pₘ, Sₘ′)
| P′ ← prepend(P′, pₘ′)
end
```

In the algorithm set forth in the preceding paragraph: (i) the revise function does the necessary step revision, so that only the required outputs are produced; (ii) for feature generation, this would cause only the needed subset of features to be generated; and (iii) the algorithm applies to a feature selection step, but a similar algorithm can be written for reducing the complexity of a classification algorithm, given a set of features for which the classification has little dependence.

Some embodiments of the present invention may include one, or more, of the following operations, features, characteristics and/or advantages: (i) not too specific nor too general; (ii) optimizes at a machine learning pipeline level; (iii) provides retrospection for a trained ML pipeline at a functional level (feature engineering, feature selection, construction, machine learning model) for optimization; and/or (iv) provides refactoring strategy based on outcome of retrospective analysis.

In designing embodiments according to the present invention, some potentially helpful practices to keep in mind are as follows: (i) inspect the best pipeline and obtain statistics on what are the most commonly used steps in a pipeline; and/or (ii) know upfront that there are certain steps which always reduce features.

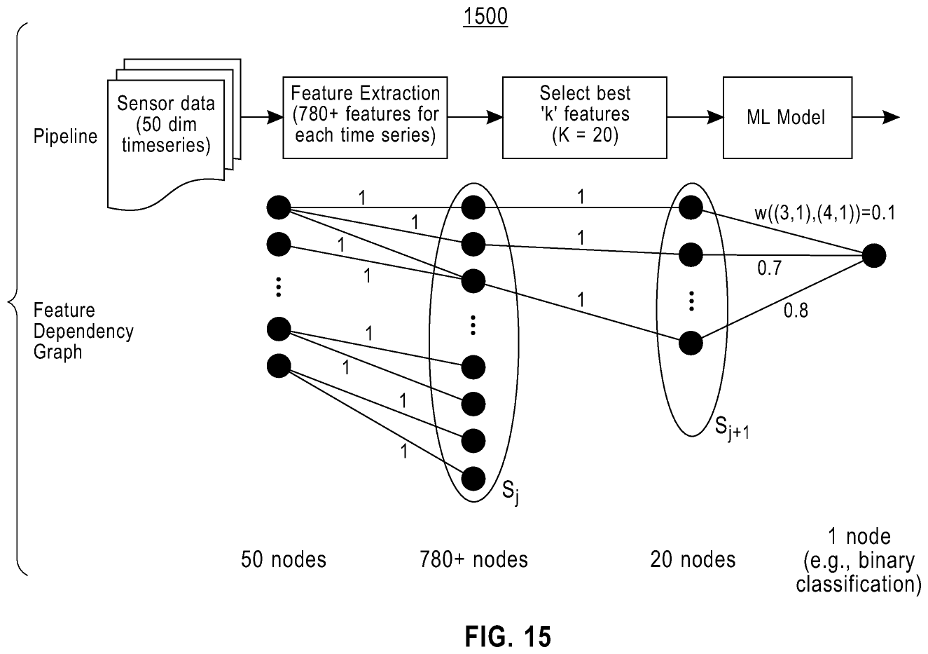

As shown in FIG. 15, diagram 1500 shows extraction of a feature dependency graph according to an embodiment of the present invention. In some embodiments, the feature dependency graph is critical for subsequent steps of the pipeline optimization process, since it captures the underlying dependencies of the different steps in the pipeline. These dependencies indicate what is required from previous steps so that subsequent steps can be completed—in turn it indicates what computation is unnecessary in these earlier steps. By eliminating such computation, pipelines are more efficient for the task at hand—saving valuable resources, while achieving the same task.

Some embodiments of the present invention may include one, or more, of the following operations, features, characteristics and/or advantages: (i) optimal deployments of AI pipelines; (ii) refactoring an authored pipeline for deployment purposes ensuring efficiency while maintaining the same level of model fidelity; (iii) a pipeline deployment tool orchestrates the examination of a pipeline, its subsequent revision, and produces a new pipeline along with associated metadata to facilitate deployment; (iv) a pipeline inspection tool examines existing trained AI pipelines and identifies steps where potential revisions could occur, a revision planner evaluates potential candidate revisions and identifies which revisions should be made given available resources, and the order in which those revisions should proceed; (v) a pipeline step revision component identifies how to revise a particular step in a pipeline according to a known set of step types and rules which can be applied (white box techniques) to reduce both input requirements and model complexity; (vi) examining inputs and outputs of a step to infer potential reductions in either input or model complexity, without understanding the specifics of the step (black box techniques); (vii) a revision propagator component takes a pipeline with a revised step, along with information about the revision, to propagate changes to ensure consistency and correctness of the pipeline; and/or (viii) comparing a candidate revised pipeline and the original pipeline to identify the fidelity with which the candidate reproduces the original pipeline behavior.

Some embodiments of the present invention may include one, or more, of the following operations, features, characteristics and/or advantages: (i) automated optimization of an AI model at the deployment stage; (ii) after training an AI model, machine logic optimizes the steps it takes to perform the same calculation with less data overhead (for example, combining steps to make for faster result calculation for new data to make overall process faster); (iii) optimize the train model before deployment step; (iv) looks into the model steps and reduce those steps for calculating the results without losing accuracy in an automated manner; (v) performs optimization of data features (hence time taken) by AI model for a single round of prediction by a trained model; (vi) implements a mechanism to optimize the internal algorithm in the deployment modules for AI models to reduce the time taken by deployment to return the results; (vii) modifies a machine learning model to reduce the size; (viii) deploys pipelines composed of feature engineering as well as model; (ix) implements multiple modules on inspecting the machine learning pipeline; (x) understands feature engineering aspect of pipeline, and working of machine learning model; (xi) does not interfere with the model training process; (xii) the pipeline optimization module is a separate module that allows a user a flexibility to use any automated machine learning tool; (xiii) optimizes machine learning pipelines to create more efficient execution of an artificial intelligence and/or machine learning pipeline; (xiv) optimizes AI models such that the number and/or computational intensity of steps for getting predictions is minimized and/or reduced; and/or (xv) faster AI model response time to the user, less memory footprint and data overhead to send over the network.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) for use with an original artificial intelligence pipeline (AIP), the CIM comprising:
orchestrating, by a pipeline deployment tool, an examination of the original AIP to yield a set of pipeline revision(s);
producing, by the pipeline deployment tool, a revised version of the AIP, along with associated metadata; and
deploying the revised version of the AIP.

2. The CIM of claim 1 further comprising:
refactoring the original AIP for deployment purposes to ensure efficiency without losing model fidelity.

3. The CIM of claim 1 wherein the production of the revised version of the AIP, along with associated metadata, includes:
examining, by a pipeline inspection tool, a plurality of existing trained AI pipelines; and
identifying, by the pipeline inspection tool, step(s) of the original AIP where potential revisions could occur;
evaluating, by a revision planner, potential candidate revision(s); and
identifying, by the revision planner, which potential candidate revision(s) should be made given available resources, and the order in which those potential candidate revision(s) should proceed.

4. The CIM of claim 1 further comprising:
determining, by a pipeline step revision component, how to revise a first step in the original AIP according to a known set of step types and rules which can be applied to reduce both input requirements and model complexity; and
examining inputs and outputs of the first step to infer potential reductions in either input or model complexity, without understanding specifics of the first step.

5. The CIM of claim 1 further comprising:
propagating, by a revision propagator component, the revised version of the AIP, along with information about the revision, to propagate changes to ensure consistency and correctness of the AIP.

6. The CIM of claim 1 further comprising:
comparing the revised version of the AIP with the original AIP to determine a fidelity level value characterizing a level of fidelity with which the revised version of the AIP reproduces the original AIP.

7. A computer program product (CPP) for use with an original artificial intelligence pipeline (AIP), the CPP comprising:
a set of storage device(s); and
computer code stored on the set of storage device(s), with the computer code including data and instructions for causing a processor(s) set to perform the following operations:
orchestrating, by a pipeline deployment tool, an examination of the original AIP to yield a set of pipeline revision(s),
producing, by the pipeline deployment tool, a revised version of the AIP, along with associated metadata, and
deploying the revised version of the AIP.

8. The CPP of claim 7 wherein the computer code further includes data and instructions for causing the processor(s) set to perform the following operation(s):
refactoring the original AIP for deployment purposes to ensure efficiency without losing model fidelity.

9. The CPP of claim 7 wherein the production of the revised version of the AIP, along with associated metadata, includes:
examining, by a pipeline inspection tool, a plurality of existing trained AI pipelines; and
identifying, by the pipeline inspection tool, step(s) of the original AIP where potential revisions could occur;
evaluating, by a revision planner, potential candidate revision(s); and
identifying, by the revision planner, which potential candidate revision(s) should be made given available resources, and the order in which those potential candidate revision(s) should proceed.

10. The CPP of claim 7 wherein the computer code further includes data and instructions for causing the processor(s) set to perform the following operation(s):
determining, by a pipeline step revision component, how to revise a first step in the original AIP according to a known set of step types and rules which can be applied to reduce both input requirements and model complexity; and
examining inputs and outputs of the first step to infer potential reductions in either input or model complexity, without understanding specifics of the first step.

11. The CPP of claim 7 wherein the computer code further includes data and instructions for causing the processor(s) set to perform the following operation(s):
propagating, by a revision propagator component, the revised version of the AIP, along with information about the revision, to propagate changes to ensure consistency and correctness of the AIP.

12. The CPP of claim 7 further comprising:
comparing the revised version of the AIP with the original AIP to determine a fidelity level value characterizing a level of fidelity with which the revised version of the AIP reproduces the original AIP.

13. The CPP of claim 7 further comprising the processor(s) set, wherein the CPP is in the form of a computer system (CS).

14. The CS of claim 13 wherein the computer code further includes data and instructions for causing the processor(s) set to perform the following operation(s):
refactoring the original AIP for deployment purposes to ensure efficiency without losing model fidelity.

15. The CS of claim 13 wherein the production of the revised version of the AIP, along with associated metadata, includes:
examining, by a pipeline inspection tool, a plurality of existing trained AI pipelines;
identifying, by the pipeline inspection tool, step(s) of the original AIP where potential revisions could occur;
evaluating, by a revision planner, potential candidate revision(s); and
identifying, by the revision planner, which potential candidate revision(s) should be made given available resources, and the order in which those potential candidate revision(s) should proceed.

16. The CS of claim 13 wherein the computer code further includes data and instructions for causing the processor(s) set to perform the following operation(s):
determining, by a pipeline step revision component, how to revise a first step in the original AIP according to a known set of step types and rules which can be applied to reduce both input requirements and model complexity; and
examining inputs and outputs of the first step to infer potential reductions in either input or model complexity, without understanding specifics of the first step.

17. The CS of claim 13 wherein the computer code further includes data and instructions for causing the processor(s) set to perform the following operation(s):
propagating, by a revision propagator component, the revised version of the AIP, along with information about the revision, to propagate changes to ensure consistency and correctness of the AIP.

18. A computer-implemented method (CIM) comprising:
receiving computer code corresponding to an original version of a machine learning module (ML mod) structured and/or programmed to: (i) receive input data that includes X input parameter values respectively corresponding to X parameters, where X is an integer greater than one, (ii) to select Y input parameter values of the X input parameters to obtain Y selected/extracted parameter values, where Y is an integer less than or equal to X, and (iii) apply an ML algorithm, which has been developed, at least in part, by ML, to the Y selected/extracted parameter values to obtain a recommendation;
performing feature selection, by machine logic, to obtain updated value(s) for at least one of the following variables: X and/or Y; and
revising, by machine logic, the original version of the ML mod to obtain an updated version of the ML mod that is characterized by the updated value(s) for X and/or Y.

19. The CIM of claim 18 wherein the performance of feature selection decreases the value of X such that the updated version of the ML mod is programmed to accept fewer input parameter values than the original version of the ML mod.

20. The CIM of claim 18 wherein the performance of feature selection decreases the value of Y such that the updated version of the ML mod is programmed to use fewer selected/extracted parameter values in the ML algorithm than the original version of the ML mod.
